(19) United States
(12) Patent Application Publication
(10) Pub. No.: US 2018/0372159 A1
(43) Pub. Date: Dec. 27, 2018

(54) PRELOAD ADJUSTMENT IN A BEARING ASSEMBLY

(71) Applicant: Aktiebolaget SKF, Goteborg (SE)

(72) Inventor: Thomas Friedrich, Hausen (DE)

(21) Appl. No.: 16/010,724

(22) Filed: Jun. 18, 2018

(30) Foreign Application Priority Data
Jun. 27, 2017 (DE) 102017210752.9

(51) Int. Cl. F16C 37/00; F25B 21/04; F16C 19/16

(52) U.S. Cl. CPC F16C 37/007; F16C 2229/00; F16C 19/163; F25B 21/04

(57) ABSTRACT

A rolling-element bearing assembly includes a first bearing and a second bearing, and each of the first and second bearings includes an inner and outer ring separated by at least one spacer ring. At least one Peltier element in disposed in the at least one spacer ring for changing the temperature of the spacer ring and thereby changing a preload of the bearing assembly.

### CROSS-REFERENCE

This application claims priority to German patent application no. 10 2017 210 752.9 filed on Jun. 27, 2017, the contents of which are fully incorporated herein by reference.

### TECHNOLOGICAL FIELD

The present disclosure relates to a bearing assembly, in particular a rolling-element bearing assembly, including at least two bearings, wherein each bearing includes an inner ring and an outer ring that are rotatably disposed relative to each other, and including at least one inner and/or one outer spacer ring, wherein the inner spacer ring is disposed between the inner rings of the at least two bearings and/or the outer spacer ring is disposed between the outer rings of the at least two bearings.

### BACKGROUND

Some bearing assemblies, for example, angular contact ball bearings, are used in assemblies of two or more bearings in order to support all impinging loads. The two or more bearings here can be held at a distance by spacer rings that are disposed between the inner rings or the outer rings. These spacer rings can additionally be used to adapt the preload of the bearings with respect to each other by the spacer rings having different dimensions. For example, in a back-to-back arrangement a shorter—i.e., an axially smaller—spacer ring can be used between the inner rings in order to increase the preload, and a shorter—i.e., axially smaller—spacer ring can be used between the outer rings in order to decrease the preload. In a face-to-face arrangement this applies in reverse. This adapting is necessary inter alia to compensate for different influences on the bearing. These include inter alia a press fit of the inner rings, thermal expansion of all parts of the bearing, or kinematic behavior such as centrifugal force effects due to high rotational speeds. Such an adapting is often a compromise between preload and stiffness, between speed capability and operating temperature.

To date this adapting has been achieved by calculating different operating conditions for a certain bearing assembly, and based on the results, a certain difference between the width of the inner spacer ring and that of the outer spacer ring is determined. Spring-operated bearing adjustment represents an alternative to fixed preload adjustment using adapted spacer rings. Here spring elements, for example, spiral compression springs, are used, which axially preload the bearing. The preload is determined here via the resulting spring force. A disadvantage of this arrangement is a reduced stiffness of the bearing assembly against the pressure direction of the effective spring force.

Furthermore, with adapted spacer rings there is the problem that in operation the bearing and also the spacer rings heat and expand due to thermal causes so that they thereby lose their dimensional stability. Due to these dimension-changing temperature influences the preload of the bearing is also changed. In order to compensate for the thermal effects it has been proposed to partially integrate a liquid cooling into the bearing assembly. In this way the dimension-changing temperature influences on the bearing assembly can be reduced, and the change of the bearing preload minimized. However, such a water cooling requires much space and additional components such as, for example, seals. Furthermore, no dynamic adapting can be effected by such a liquid cooling since the reaction times of a liquid cooling are very long and their effect on the components to be cooled is very slow.

### SUMMARY

An aspect of the present disclosure is therefore to provide a bearing assembly, using which a dynamic adapting of the preload between the bearings is possible.

In the following a bearing assembly, in particular a rolling-element bearing assembly, including at least two bearings, wherein each bearing includes an inner ring and an outer ring that are disposed rotatable relative to each other, and including at least one inner and/or one outer spacer ring is presented, wherein the inner spacer ring is disposed between the inner rings of the at least two bearings and/or the outer spacer ring is disposed between the outer rings of the at least two bearings. The two spacer rings can be provided in their dimensions such that a certain preload is achieved between the bearings. In order to also be able to maintain this preload during operation, at least one of the spacer rings includes circumferentially disposed Peltier elements. These Peltier elements are designed to counteract the dimension-changing temperature influences so that a predetermined preload is maintained.

Furthermore, as a further preferred exemplary embodiment shows, the Peltier elements can precisely induce an axial length change in at least one of the spacer rings so that the preload is adaptable overall, even during operation.

Furthermore these Peltier elements can be used to influence the temperature of at least one of the spacer rings. In this way a heating of at least one of the spacer rings can be compensated, which heating would otherwise lead to a change of the preload.

In one advantageous exemplary embodiment the Peltier elements are configured to heat and/or to cool the at least one spacer ring. In this way the preload of the bearing assembly can be maintained or even changed in a particularly simple manner By cooling a spacer ring it becomes axially shorter, while the other spacer ring is heated by operation and expands. Thus the ratio of the width of the two spacer rings to each other, and thus the preload, can be changed. Alternatively the spacer ring can be heated, whereby it becomes axially longer, while the other spacer ring is also heated by operation and expands. Thus the ratio of the width of the two spacer rings to each other and the preload can thereby be held constant. Of course it is also possible that the Peltier elements of the one spacer ring are cooled, while the Peltier elements of the other spacer ring are heated, which also leads to a change of the preload.

According to one advantageous exemplary embodiment a Peltier element respectively includes a p-doped and an n-doped semiconductor crystal, which are connected to each other via a copper bridge. N-doped semiconductor crystals have a lower energy level of the conduction band than p-doped semiconductor crystals. A cooling can therefore occur by a current flowing from the p-doped semiconductor crystal to the n-doped semiconductor crystal. The copper bridge here can in particular by disposed on the inner side of the spacer ring. The use of Peltier elements is particularly advantageous since they are very small and have a low weight.

As a further preferred exemplary embodiment shows, the n-doped and the p-doped semiconductor crystals of an adjacent Peltier element are connected to each other via a further copper bridge. In this way an electrical series connection of the Peltier elements can be achieved so that only one power supply is required.

The Peltier elements are suppliable with power via a power supply, as a further preferred exemplary embodiment shows. A heating instead of a cooling can be achieved in a simple manner by a change of the direction of the current flow.

As a further preferred exemplary embodiment shows, a temperature sensor is disposed on at least one spacer ring. By the use of a temperature sensor the temperature at the spacer ring can be monitored in a simple manner, and optionally a heating or cooling of the spacer ring can be induced via the Peltier elements.

In a further preferred exemplary embodiment the outer spacer ring includes the Peltier elements. In this case a power supply can be attached from outside in a particularly simple manner.

In addition the inner spacer ring can include Peltier elements. An adapting of the width via a heating or cooling can thereby be effected not only by the outer but also by the inner spacer ring. In this way the adapting of the preload can be further improved.

As a further preferred exemplary embodiment shows, the at least two bearings are angular contact ball bearings. Angular contact ball bearings are often realized in an assembly of a plurality of bearings. Here an adapting of the spacer rings, and thus of the preload, by Peltier elements is particularly advantageous.

Further advantages and advantageous embodiments are defined in the claims, the description, and the drawings. Further possible designs of the disclosure also comprise combinations not explicitly mentioned of features or embodiments described above or in the following with respect to the exemplary embodiments. Here the person skilled in the art will also add individual aspects as improvements or additions to the respective base form of the disclosure.

In the following the disclosure is described in more detail using the exemplary embodiments depicted in the drawings. Here the exemplary embodiments are of a purely exemplary nature and are not intended to establish the scope of the application. This scope is defined solely by the pending claims.

### BRIEF DESCRIPTION OF THE DRAWINGS

FIG. 1 shows a schematic sectional view through a preferred exemplary embodiment of a bearing assembly.

FIG. 2 shows a schematic sectional view through a preferred exemplary embodiment of a spacer ring.

FIG. 3 shows a schematic sectional view through a preferred exemplary embodiment of two spacer rings.

### DETAILED DESCRIPTION

In the following, identical or functionally equivalent elements are designated by the same reference numbers.

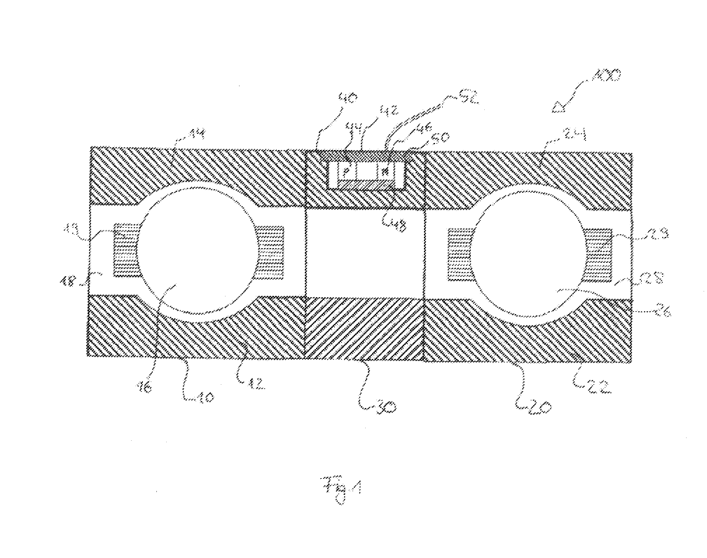

FIG. 1 shows a bearing assembly 100. The bearing assembly 100 includes two bearings 10, 20, each including an inner ring 12, 22 and an outer ring 14, 24. The inner ring 12, 22 and the outer ring 14, 24 are rotatably disposed with respect to each other. A bearing interior 18, 28 is respectively formed between these two bearing rings 12, 22 and 14, 24, in which the rolling elements 16, 26 are disposed. These rolling elements 16, 26 can be received in a rolling-element bearing cage 19, 29.

Between the two inner rings 12, 22 an inner spacer ring 30 is disposed, and between the two outer rings 14, 24 an outer spacer ring 40 is disposed. In the exemplary embodiment shown in FIG. 1 the outer spacer ring 40 includes Peltier elements 42. Alternatively or additionally the inner spacer ring 30 can also include such Peltier elements.

The Peltier elements 42 are circumferentially disposed and preferably uniformly spaced with respect to one another. Each Peltier element 42 includes a p-doped semiconductor crystal 44 and an n-doped semiconductor crystal 46. The two semiconductor crystals 44, 46 are connected to each other via a copper bridge 48. Although for the purposes of illustration the two semiconductor crystals 44, 46 are depicted disposed adjacent to each other, they are disposed in succession circumferentially in the spacer ring 40. The semiconductor crystals 44, 46 of adjacent Peltier elements 42 are also connected via a copper bridge 50. In this way the Peltier elements 42 can be connected electrically in series. All Peltier elements 42 can thus be supplied with power via a single power supply 52. Via the power supply 52 the Peltier elements 42 can now be used for cooling or for heating the spacer ring 40. The spacer ring 40 can thus change its extension between the two outer rings 14, 24, whereby the preload between the bearings 10, 20 changes or can be maintained.

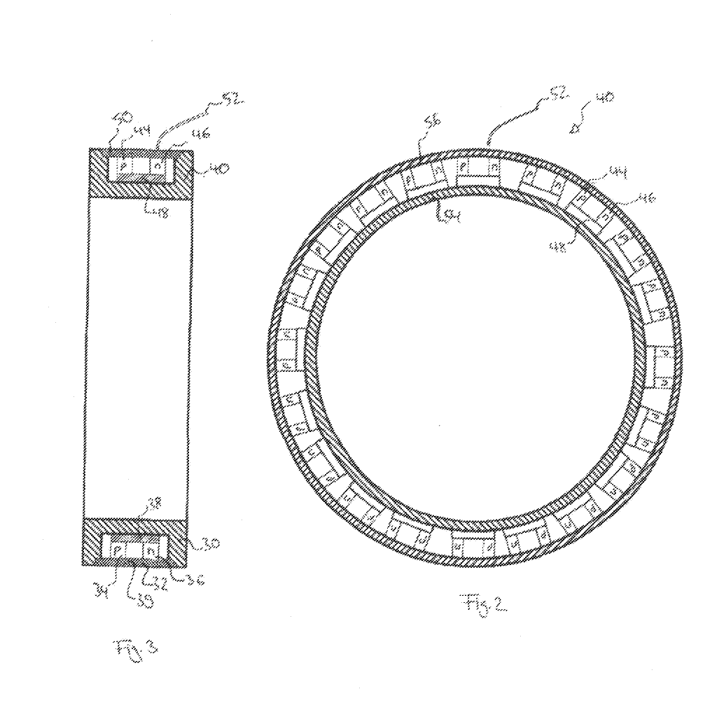

As shown in FIG. 2, the Peltier elements 42 of the spacer ring 40 are disposed successively such that in the successive Peltier elements 42 p-doped semiconductor crystals 44 and n-doped semiconductor crystals 46 alternate. The spacer ring 40 can include an inner ring 54 and an outer ring 56 in order to ensure a stable spacer ring 40. The Peltier elements 42 are then disposed between the inner ring 54 and the outer ring 56.

In addition to the Peltier elements 42 in the outer spacer ring 40, Peltier elements 32 can also be disposed in the inner spacer ring 30, as is shown in FIG. 3. These Peltier elements 32 are constructed analogously to the Peltier elements 42. This means that the Peltier elements 32 are also disposed circumferentially, wherein each Peltier element 32 includes a p-doped semiconductor crystal 34 and an n-doped semiconductor crystal 36. The two semiconductor crystals 34, 36 are connected to each other via a copper bridge 38. For the purposes of illustration the two semiconductor crystals 34, 36 are also depicted disposed adjacent to each other in FIG. 3. The semiconductor crystals 34, 36 of adjacent Peltier elements 32 are also connected via a copper bridge 39. The adapting of the preload can be particularly advantageously influenced by Peltier elements in the inner spacer ring 30 and the outer spacer ring 40.

By the bearing assembly 100 described herein it is possible to realize in a simple manner an adapting of the preload between the bearings 10, 20 by being able to heat and/or cool at least one of the spacer rings 30, 40 via Peltier elements 32, 42. Here in particular no expensive cooling measures via water cooling are required.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved preload adjustment in bearing assemblies.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMBER LIST

10 Bearing
12 Inner ring
14 Outer ring
16 Rolling-element bearing
18 Bearing interior
19 Rolling-element bearing cage
20 Bearing
22 Inner ring
24 Outer ring
26 Rolling element
28 Bearing interior
29 Rolling-element bearing cage
30 Inner spacer ring
32 Peltier element
34 P-doped semiconductor crystal
36 N-doped semiconductor crystal
38 Copper bridge
39 Copper bridge
40 Inner spacer ring
42 Peltier element
44 P-doped semiconductor crystal
46 N-doped semiconductor crystal
48 Copper bridge
50 Copper bridge
52 Power supply
54 Inner ring
56 Outer ring
100 Bearing assembly

What is claimed is:

1. A rolling-element bearing assembly comprising:
a first bearing and a second bearing, each of the first and second bearings including an inner ring and an outer ring rotatably disposed relative to each other,
at least one spacer ring disposed between the inner ring of the first bearing and the inner ring of the second bearing or between the outer ring of the first bearing and the outer ring of the second bearing; and
at least one Peltier element in the at least one spacer ring.

2. The bearing assembly according to claim 1, wherein the at least one Peltier element comprises a plurality of Peltier elements, and wherein the plurality of Peltier elements are circumferentially disposed along the at least one spacer ring.

3. The bearing assembly according to claim 2, wherein the at least one Peltier element is positioned to change an axial length of the at least one spacer ring to adjust a preload of the first bearing with respect to the second bearing.

4. The bearing assembly according to claim 2, wherein the at least one Peltier element is configured to heat and/or to cool the at least one spacer ring.

5. The bearing assembly according to claim 2, wherein the at least one Peltier element includes a p-doped semiconductor crystal and an n-doped semiconductor crystal connected to each other via a first copper bridge.

6. The bearing assembly according to claim 5, wherein the at least one Peltier element comprises a first Peltier element and a second Peltier element connected to the first Peltier element by a second copper bridge.

7. The bearing assembly according to claim 2 including a power supply operatively connected to the at least one Peltier element.

8. The bearing assembly according to claim 2, including a temperature sensor disposed on the at least one spacer ring.

9. The bearing assembly according to claim 2, wherein the at least one spacer ring is disposed between the outer ring of the first bearing and the outer ring of the second bearing.

10. The bearing assembly according to claim 2, wherein the at least one spacer ring is disposed between the inner ring of the first bearing and the inner ring of the second bearing.

11. The bearing assembly according to claim 10, wherein the at least one spacer ring is disposed between the outer ring of the first bearing and the outer ring of the second bearing.

12. The bearing assembly according to claim 2, wherein the first bearing and the second bearing are angular contact ball bearings.

13. The bearing assembly according to claim 2,
including a power supply operatively connected to the at least one Peltier element and a temperature sensor disposed on the at least one spacer ring,
wherein the at least one Peltier element is positioned to change an axial length of the at least one spacer ring to adjust a preload of the first bearing with respect to the second bearing,
wherein the at least one Peltier element is configured to heat and/or to cool the at least one spacer ring,
wherein the at least one Peltier element includes a p-doped semiconductor crystal and an n-doped semiconductor crystal connected to each other via a first copper bridge,
wherein the at least one Peltier element comprises a first Peltier element and a second Peltier element connected to the first Peltier element by a second copper bridge.

14. A rolling-element bearing assembly comprising:
a first bearing and a second bearing, each of the first and second bearings including an inner ring and an outer ring rotatably disposed relative to each other, and
means for adjusting a preload of the first bearing relative to the second bearing.

15. The rolling-element bearing according to claim 14, wherein the means for adjusting includes at least one Peltier element.

16. The rolling-element bearing according to claim 15, wherein the means for adjusting includes at least one spacer ring between the first and second bearings.

17. The rolling-element bearing according to claim 16, wherein the at least one Peltier element comprises a plurality of Peltier elements circumferentially disposed along the at least one spacer ring.
